(19) United States
(12) Patent Application Publication
(10) Pub. No.: US 2025/0100252 A1
(43) Pub. Date: Mar. 27, 2025

(54) METHOD AND DEVICE FOR ASSEMBLING A TRIPLE INSULATING GLASS PANE HAVING TWO OUTER GLASSES AND A THIN GLASS BETWEEN THEM

(71) Applicant: Glaston Germany GmbH, Neuhausen-Hamberg (DE)

(72) Inventors: Tobias Schweigert, Neuhausen (DE); Stephan Kammerer, Neuhausen (DE)

(73) Assignee: Glaston Germany GmbH, Neuhausen-Hamberg (DE)

(21) Appl. No.: 18/823,511

(22) Filed: Sep. 3, 2024

(30) Foreign Application Priority Data
Sep. 26, 2023 (DE) 10 2023 126 130.4

(51) Int. Cl. B32B 17/10; E06B 3/673

(52) U.S. Cl. CPC B32B 17/10816; B32B 17/10055; B32B 17/10302; E06B 3/6733; E06B 3/67369; E06B 3/67373; E06B 3/67382; E06B 3/67386

(57) ABSTRACT

A method and a device for assembling a triple insulating glass pane containing two outer glasses and a thin glass between them is disclosed. A standing thin glass is conveyed into a first pressing station. A first flexible spacer strand is applied to a first outer glass, which is then joined to the thin glass in the first pressing station. A second flexible spacer strand is applied to the second outer glass. The glass assembly is conveyed upstandingly to a turning station, where it is turned about an upstanding axis of rotation. After turning, the glass assembly is conveyed upstandingly from the rotation station into a second pressing station. The second outer glass is conveyed upstandingly through the first pressing station and the rotation station into the second pressing station. Then, the glass assembly and the second outer glass are joined together to form a triple insulating glass pane.

### CROSS-REFERENCE TO RELATED APPLICATIONS

This application claims priority to the German application number 10 2023 126 130.4 filed on Sep. 26, 2023, the entire content of which is fully incorporated herein with this reference.

### DESCRIPTION

### Field of the Invention

The invention starts from a method and a device for assembling a triple insulating glass pane. Triple insulating glass panes are produced industrially in large quantities in production lines, with a first, a second and a third glass sheet being fed in succession to a device with an application station and a pressing station arranged downstream of the application station. Each of the stations has a horizontal conveyor on which the glass sheets are transported one behind the other in an upstanding position. Each horizontal conveyor has a supporting wall on which the upstanding glass sheets are supported at an angle of a few degrees to the rear. The first and third glass sheets each form an outer glass of the finished insulating glass pane. The second glass sheet forms the middle glass of the finished insulating glass pane. In the application station, a flexible spacer strand is applied to each of the second and third glass sheets. In the pressing station, the three glass sheets are assembled to form a triple insulating glass pane and, if necessary, are filled with a gas other than air.

### Background of the Invention

WO 2020/028056 A1 discloses triple insulating glass panes in which the middle glass is formed by a thin glass. The insulating glass pane has a thin glass with a thickness of 0.5 mm between two outer glasses with a thickness of 5 mm each. The thin glass is thus unstable. It bends and can break very easily. Insulating glass panes with thin glass, which has a thickness of 2 mm or less, cannot yet be produced on the known industrial production lines, where the glass sheets are transported and processed upstandingly on a single-track horizontal conveyor, due to the difficulties involved in transporting and handling the thin glass. They have therefore mainly been produced by hand using rigid, prefabricated spacer frames. The time required to assemble such insulating glass panes has therefore been very high to date.

Furthermore, EP 2 802 727 B1 and DE 10 2019 123 700 A1 describe non-standard devices and methods for assembling insulating glass panes with turning stations and pressing stations, each of which contains two horizontal conveyors with parallel conveyor tracks next to each other. This means that two glass sheets can be positioned and transported next to each other in one station. The two glass sheets are positioned in a V-shape in the station and are supported by two opposing supporting walls, which are also inclined in opposite directions in a V-shape. The two pressing plates in such a pressing station are therefore also V-shaped in relation to each other and must therefore be pivoted in relation to each other during the pressing process. Such devices and processes have been described from time to time in the patent literature, but have not yet found their way into the industrial production of insulating glass panes.

It may be an object of the invention to create a method and a device for assembling a triple insulating glass pane containing two outer glasses and a thin glass between them, in which, in particular, the time for manufacturing such an insulating glass pane is reduced.

This object of the invention may be achieved by a method having the features of the independent claim and a device having the features of another claim. Advantageous further embodiments may be subject of dependent claims.

### SUMMARY OF THE INVENTION

In the process according to the invention, a standing thin glass is conveyed through a first application station into a first pressing station. The thin glass is thus fed as a first glass sheet. The thin glass is conveyed into the first pressing station standing on its lower edge. The thin glass is conveyed through the application station interruption-free, i.e., without being stopped and without being treated by the application station while standing on its edge. In other words, no spacer strand is applied to the thin glass. A first outer glass is fed as the second glass sheet. The first outer glass is conveyed upstandingly into the application station. In the application station, a first flexible spacer strand is applied to the first outer glass so that the first spacer strand forms a frame-shaped spacer on the first outer glass. After the spacer strand has been applied, the first outer glass is conveyed upstandingly from the application station into the first pressing station. A second outer glass is fed as the third glass sheet. The second outer glass is conveyed upstandingly into the application station. In the application station, a second flexible spacer strand is applied to the second outer glass so that the second spacer strand forms a frame-shaped spacer on the second outer glass. In the first pressing station, the thin glass and the first outer glass are joined together to form a glass assembly. During assembly, the thin glass and outer glass are parallel to each other. The distance between the thin glass and the first outer glass is reduced until the thin glass rests on the first spacer strand and is at a predefined distance to the first outer glass. The glass assembly is conveyed upstandingly from the first pressing station into a turning station, where it is turned around an upstanding axis of rotation. After turning, the glass assembly is conveyed upstandingly from the turning station into a second pressing station. The second outer glass is conveyed upstandingly from the application station through the first pressing station and through the turning station into the second pressing station. The second outer glass is conveyed through the first pressing station after the glass assembly has left the first pressing station. The second outer glass is transported through the first pressing station interruption-free and without treatment. In the second pressing station, the glass assembly and the second outer glass are joined together to form a triple insulating glass pane. During assembly, the glass assembly and the second outer glass are parallel to each other. The distance between the glass assembly and the second outer glass is reduced until the thin glass rests on the second spacer strand and the first outer glass has a predefined distance to the second outer glass. After joining, the triple insulating glass pane is conveyed upstandingly out of the second pressing station.

The thin glass is a glass sheet with a thickness of 2 mm or less. The thin glass forms a middle glass or inner glass in the finished triple insulating glass pane. An outer glass is a glass sheet with two opposing surfaces, a first surface of which faces the thin glass in the finished insulating glass pane and a second surface of which faces outwards on the finished glass pane. The first surface of the outer glass thus forms an inner side in the finished glass pane. The second surface of the outer glass thus forms an outer side of the finished insulating glass pane. The thickness of an outer glass pane can be over 2 mm up to 15 mm. In particular, it can be in the range from 3 mm to 8 mm.

The device according to the invention for assembling a triple insulating glass pane containing two outer glasses and a thin glass between them comprises an application station. The application station is configured for applying a flexible spacer strand along an edge of an upstanding outer glass. The triple insulating glass pane has a flexible spacer strand both between the thin glass and the first outer glass as well as between the thin glass and the second outer glass. A first pressing station is arranged downstream of the application station. The first pressing station has a horizontal conveyor and two parallel pressing plates. The first pressing station is configured for joining a thin glass and a first outer glass provided with a flexible spacer strand to form a glass assembly. A turning station is arranged downstream of the first pressing station. The turning station has two parallel supporting walls and a horizontal conveyor. The horizontal conveyor is assigned to both supporting walls and can be rotated together with both supporting walls about an upstanding axis of rotation. The turning station is configured for turning a glass sheet standing on the horizontal conveyor 180° around an upstanding axis of rotation. Seen along the conveying direction, the axis of rotation is arranged centrally in relation to the horizontal conveyor. This means that after a 180° rotation, the horizontal conveyor is again in the same line as before the rotation. A second pressing station is arranged downstream of the turning station. The second pressing station has a horizontal conveyor and two parallel pressing plates. In both the first pressing station and the second pressing station, the distance between the two pressing plates can be changed. When the distance between the two pressing plates of a pressing station is changed, the two pressing plates remain oriented parallel to each other. The second pressing station is configured for joining a thin glass of a glass assembly with a second outer glass, which is provided with a flexible spacer strand. Both the turning station and the two pressing stations, in particular, all stations of the device according to the invention, can each contain only one single-track horizontal conveyor. The term “single-track” refers to a horizontal conveyor which has only one conveyor track. The horizontal conveyor can be configured for conveying standing glass sheets in a straight line through the respective station. The horizontal conveyor can contain several transport rollers arranged in a row and/or a horizontally running conveyor belt to transport a glass sheet standing on its lower edge. All horizontal conveyors can be arranged one behind the other along a straight line.

Both the first pressing station and the second pressing station are designed as follows. A first of the two pressing plates forms an upstanding supporting wall for a glass sheet transported upstandingly on the horizontal conveyor. The feature “upstanding” means that the supporting wall is not exactly vertical or aligned with a plummet, but is inclined backwards by a few degrees so that an upstanding glass sheet leaning against the supporting wall does not tip forwards, i.e., away from the supporting wall. A supporting wall can have an inclination of around 6° to 8° to the vertical. The first pressing plate can be arranged in a fixed position. A second of the two pressing plates can be displaceable transversely to the first pressing plate in order to change the distance between the two pressing plates. When the second pressing plate is displaced, the second pressing plate remains parallel to the first pressing plate. The pressing station can have a suction device for sucking a glass sheet onto the second pressing plate. The pressing station can be configured for filling the space between the glass sheets with a gas other than air. The design and mode of operation of such pressing stations is known per se from decades of use in the industrial manufacture of insulating glass panes as well as from EP 0 539 407 B1 and EP 1 769 130 B1 and therefore does not need to be described in more detail.

In the application station, a flexible spacer strip is applied along the edge of an upstanding glass sheet, namely onto the first and second outer glass, in a manner known per se. This means that no pre-assembled spacer frame is placed on the glass sheet. The spacer strand can be applied gap-free along the edge of the glass sheet. Only a spacer strand applied along the entire edge of the glass sheet creates a spacer frame to keep two adjacent glass sheets at a distance. The flexible spacer strand can be a pasty and then solidifying spacer strand made of a thermoplastic material and/or a reactive cross-linking material, which is applied to the glass sheet using a nozzle. The flexible spacer strand is therefore still hot and/or not yet fully cured after application. The flexible spacer strand can also be unrolled from a supply roll as a ribbon-shaped material and applied onto the glass sheet. The application station can contain an application head, which is guided along at least a section of the edge of the outer glass in order to apply the spacer strand.

The invention may have (but which are not necessary) significant advantages:

The invention makes it possible to process upstanding thin glass with flexible spacer strands into a triple insulating glass pane on an industrial scale.

An upstanding thin glass can be inserted between two outer glass sheets, with spacer strands only being applied onto the two outer glass sheets. It is not necessary to apply a spacer strand onto the thin glass.

The inventors have recognized that the application of flexible spacer strands to thin glass can cause considerable problems. When applying the hot material of a thermoplastic spacer strand to thin glass, a large amount of heat would be introduced into the thin glass at certain points, causing it to become very deformed. It becomes so wavy that further processing would not be possible. This is avoided by the present invention. A thermoplastic spacer strand applied to the outer glass is already sufficiently cooled when it is joined to the thin glass in the pressing station. Furthermore, when the thin glass is placed on the finished spacer, the heat is not introduced into the thin glass at specific points, but essentially evenly along the entire edge. This may prevent unacceptably high deformations and waviness of the thin glass as well as unacceptably high distortion and stresses in the thin glass.

The inventors have also recognized that a flexible spacer strand, which is pulled from a supply roll and applied to a glass sheet by machine, is under prestress, which would lead to an unacceptably high curvature of the thin glass if applied directly to a thin glass.

The present invention enables flexible spacer strands to be applied exclusively to the two stable outer glasses. These can compensate sufficiently well for the stresses introduced into the glass sheet during application of the spacer strand due to their high inherent stability. If an outer glass with the spacer strand applied along its entire edge is then joined with the thin glass, this no longer causes any unacceptably high stresses and/or deformation of the thin glass.

Triple insulating glass panes containing thin glass can be produced very quickly and with short cycle times using the invention. Triple insulating glass panes containing thin glass are thus available in large quantities and can be produced in the same thickness as previous double insulating glass panes. Old double insulating glass panes can therefore be replaced with better insulating triple insulating glass panes without the need for structural changes to window frames. This can simplify the modernization of buildings.

Using a spacer, which is not yet pre-assembled in the shape of a frame, means that glass sheets in special formats and/or with non-rectangular outer contours can be easily and flexibly processed into triple insulating glass panes.

With the invention, existing single-track production lines for the manufacture of insulating glass can be retrofitted with relatively little effort and with relatively little additional space requirement in order to make them suitable for assembling triple insulating glass panes containing thin glass.

A further advantage of the device according to the invention is that it can also be used to produce double and triple insulating glass panes without thin glass very quickly and with a very short cycle time, as an insulating glass pane can each be assembled in the first and second pressing station at the same time and, if necessary, filled with gas. The turning station is not in operation in such a case. Glass sheets for a first insulating glass pane are transported through the first pressing station and the turning station into the second pressing station. No processing steps are carried out on the first insulating glass pane in the first pressing station and the turning station. While the first insulating glass pane is being assembled in the second pressing station and, if necessary, filled with gas, glass sheets for a second insulating glass pane can already be transported into the first pressing station and assembled there. The assembly and gas filling of the second insulating glass pane in the first pressing station therefore takes place in parallel with the assembly and gas filling of the first insulating glass pane in the second pressing station. The second insulating glass pane is then transported through the turning station and the second pressing station without any processing steps. Since the assembly and gas filling in the pressing station takes more time than the processing in the other stations of a production line, the productivity of the production line can be greatly increased overall with a device according to the invention.

The device can comprise a control system which is coupled to the application station, the turning station and the two pressing stations. The control system is configured for controlling the stations for assembling a thin glass and two outer glasses to form a triple insulating glass pane. The device can include a visual inspection station with a horizontal conveyor and several, in particular, three, supporting beams for supporting a glass sheet standing on the horizontal conveyor. The supporting beams extend horizontally. The supporting beams are displaceable up and down while being equidistant relative to each other. The distance from the supporting beams to the horizontal conveyor can therefore be adjusted.

In a further embodiment of the process, the thin glass supported by the first pressing plate is sucked onto the second pressing plate in the first pressing station. For this purpose, the first pressing station can have a suction device for sucking the thin glass onto the second pressing plate. Thereafter, the second pressing plate with the thin glass sucked onto it is moved away from the first pressing plate. This is done by increasing the distance between the two pressing plates. The first outer glass is conveyed into the first pressing station, where it is supported by the first pressing plate. In the first pressing station, the first outer glass is positioned congruently or concentrically to the thin glass sucked onto the second pressing plate. After the thin glass has been joined to the first outer glass, the suction of the thin glass onto the second pressing plate is terminated. The edge length of the thin glass can be a few millimeters, for example 3 mm, smaller than the edge length of the outer glass. In such a case, the thin glass can be raised in the first pressing station and/or the first outer glass can be lowered until the thin glass is positioned concentrically to the first outer glass. Raising and/or lowering can be achieved, for example, by inclining a conveyor belt of the horizontal conveyor in the first pressing station by a corresponding angle before the glass sheet resting on the conveyor belt is sucked onto the corresponding pressing plate. Inclining a conveyor belt is known per se and is described, for example, in EP 1 769 130 B1. The first outer glass and the smaller thin glass are positioned in relation to each other so that the edge of the thin glass lies completely inside the edge of the first outer glass. Such a triple insulating glass pane is also referred to as a “pane stepped on all four sides”. The sensitive edge of the thin glass is thus better protected against damage.

In a further embodiment, the thin glass supported by the first pressing plate can first be sucked onto the first pressing plate in the first pressing station. The second pressing plate is placed against the thin glass, meanwhile the suction of the thin glass against the first pressing plate is continued. The thin glass is sucked onto the second pressing plate before the suction of the thin glass onto the first pressing plate is terminated. The thin glass is therefore held between the two pressing plates of the first pressing station for a certain period of time and is sucked onto both pressing plates simultaneously. This ensures particularly good planarity of the thin glass. Full-surface suction of the thin glass can reduce distortion of the thin glass when it is subsequently placed on a still-warm thermoplastic spacer strand.

In a further embodiment, the outer glass of the glass assembly can be sucked onto the second pressing plate of the second pressing station. Before suction, the glass assembly is supported on the thin glass by the first pressing plate of the second pressing station. The second pressing plate with the glass assembly sucked onto it is moved away from the first pressing plate. The second outer glass is conveyed into the second pressing station, where it is supported by the first pressing plate. In the second pressing station, the second outer glass is positioned congruently or concentrically to the first outer glass sucked onto the second pressing plate. After the glass assembly has been joined to the second outer glass, the suction of the first outer glass to the second pressing plate is terminated.

Both with regard to the first outer glass and with regard to the second outer glass, the spacer strand is applied to a surface of the outer glass which faces the thin glass in the finished triple insulating glass pane, i.e., which later comes to lie inside the finished triple insulating glass pane. In the application station, the respective upstanding outer glass is supported on its surface, which later forms the outside of the insulating glass pane. During upstanding transportation to the first pressing station, the first outer glass is supported on the surface that will later form the outside of the insulating glass pane. After the thin glass has been joined to the first outer glass in the first pressing station, the upstanding glass assembly is supported on the first outer glass. The glass assembly is supported on the first outer glass while it is transported upstandingly into the turning station. The turning station is configured for turning a glass assembly about an upstanding, in particular, vertical, axis of rotation and for conveying the turned glass assembly to a downstream station. The turning station is also configured for conveying an outer glass provided with a spacer strand unrotated to a downstream station. During the rotation of the glass assembly in the turning station, the side on which the glass assembly is supported is changed. For this purpose, the two parallel supporting walls of the turning station can be tilted around a horizontal axis. At the end of the process in the turning station, the standing glass assembly is supported on the thin glass. The glass assembly is supported on the thin glass while it is transported upstandingly into the second pressing station. The second outer glass is supported on its surface, which later forms the outside of the insulating glass pane, during upstanding transportation into the second pressing station. The second outer glass is transported through the turning station without turning. The assembled triple insulating glass pane is supported on the second outer glass in the second pressing station, and, in particular, during transportation out of the second pressing station.

In a further embodiment, the turning station can have a base frame that is stationary on the floor. A rotating frame is mounted to the base frame. The rotating frame is rotatable relative to the base frame. A swivel joint can be arranged between the rotating frame and the base frame for this purpose. The axis of rotation of the swivel joint is vertical or aligned with a plummet. A tilting frame is mounted to the rotating frame. The tilting frame is tiltable about a horizontal tilting axis relative to the rotating frame. A tilting joint is arranged between the rotating frame and the tilting frame. The supporting walls and the horizontal conveyor are fixed to the tilting frame, in particular, in a way being immovable relative to one another. The tilting axis extends parallel to the conveying direction of the horizontal conveyor. The tilting axis is perpendicular to the axis of rotation. The tilting joint and the tilting frame as well as all parts fixed to it rotate in a horizontal plane during rotation with the rotating frame. This prevents the horizontal conveyor and/or the supporting walls from touching the floor with one of their outer ends during rotation.

In a further embodiment, one of the stations can have an air cushion supporting wall with a planar supporting surface. The supporting wall is configured for supporting a glass sheet transported upstandingly on the horizontal conveyor. A plurality of air ducts can open into the supporting surface. When subjected to positive pressure, an air flow emerges from the air ducts obliquely to the supporting surface. This creates an air cushion on the supporting surface on which the transported glass sheet, in particular, the thin glass, can rest and slide without touching the supporting surface. An obliquely upward blowing flow is generated on the supporting wall. This means that a machine operator standing in front of the station is not blown at directly. At least one of the air ducts, in particular, each of the air ducts, can contain an end duct section that extends obliquely to the supporting surface. In a vertical section through the supporting wall, the end duct section can extend at an angle of 45° or less, in particular, from 30° to 45°, to the supporting surface. Such an inclined blowing flow can create an air cushion that makes it much easier to transport thin glass. In particular, the first pressing station can comprise such an air cushion supporting wall. The air cushion supporting wall can be formed by the first pressing plate. An intermediate station can be arranged between the application station and the first pressing station. The intermediate station contains a horizontal conveyor and an air cushion supporting wall according to the invention. An intermediate station can be used to temporarily store a glass sheet. A glass sheet which has left the station upstream of the intermediate station can wait in the intermediate station until it can be transported into a station downstream of the intermediate station. The device according to the invention can comprise several such intermediate stations.

At least one of the pressing plates, in particular, the first pressing plate of the first pressing station, can have a planar supporting surface into which a plurality of air ducts open, wherein the air ducts form suction devices when subjected to negative pressure in order to suck a thin glass planar against the supporting surface. The air ducts in the pressing plate can be pressurized with either negative or positive pressure. This allows the functions of a suction device and an air cushion supporting wall to be combined in the pressing plate. A pressing plate can thus optionally act as an air cushion supporting wall during transportation or hold a glass sheet in place by suction during assembly.

The supporting surface can have at least one depression which is connected to an end duct section of the air duct. The depression can be circular, in particular, with a diameter of 20 mm or less. A depression may be provided for each end duct section. The depression may surround the end duct section. The depression is open towards the supporting surface. The supporting surface can have at least one groove which is connected to an end duct section. In particular, the groove can extend from a depression surrounding the end duct section. The groove extends along the supporting surface and is open towards the supporting surface. The end duct section can open into the depression or the groove at an angle. All end duct sections can extend parallel to each other.

When processing thin glass with a thickness of 2 mm or less, the width of the groove is 20 mm or less. When processing thin glass with a thickness of 1.5 mm or less, the width of the groove can, in particular, be 15 mm or less. When processing thin glass with a thickness of 1 mm or less, the width of the groove can, in particular, be 10 mm or less. This ensures that the thin glass extending over the groove without support is not impermissibly deformed by the negative pressure prevailing in the air duct. The thin glass can thus be sucked onto the supporting surface in a particularly planar manner and without undesirable waviness.

The groove can contain at least two groove sections that extend at an angle to each other. Both groove sections extend along a straight line. Each of the groove sections can have a length of 60 mm or less. This is a particularly good way of preventing the thin glass from being elastically deformed by the negative pressure and bulging into the groove. Several grooves can be arranged in the supporting surface, which are connected to one end duct section. In a plan view of the supporting surface, several grooves can extend radially towards the one end duct section. The grooves can, for example, be arranged like radiated beams around the one end duct section.

In a further embodiment, the supporting surface can have a first supporting region and a second supporting region. An air duct density in the first supporting region can be greater than in the second supporting region of the supporting surface. The air duct density in a supporting region is defined as the number of air ducts that open into this supporting region divided by the total area of this supporting region. The first supporting region can extend along the edge in the lower region of the supporting wall. When subjected to positive pressure, more air jets out of the first supporting region. This reliably prevents the lower edge of the thin glass from hitting the supporting surface during transportation on the horizontal conveyor. A suctioned area fraction in the first supporting region that is suctioned by the air ducts can be larger than in the second supporting region, in particular, by increasing the area subjected to negative pressure by depressions and/or grooves. The suctioned area fraction in a supporting region is the area subjected to negative pressure divided by the total area of said supporting region. The thin glass can thus be sucked onto the supporting surface in a particularly planar manner.

### BRIEF DESCRIPTION OF THE DRAWINGS

Further details and advantages of the invention are explained with reference to embodiments of the invention and the attached drawings. Identical and corresponding components are provided therein with corresponding reference signs.

FIG. 1 is a schematic top view of an arrangement of a device according to the invention as well as some intermediate steps in the assembly of a triple insulating glass pane.

FIG. 2 shows the device of FIG. 1 with further intermediate steps in the assembly of the triple insulating glass pane.

FIG. 3 is a schematic side view of a finished triple insulating glass pane.

FIG. 4 is a schematic front view of a visual inspection station for the device according to the invention.

FIG. 5 is a schematic front view of a turning station for the device according to the invention.

FIG. 6 is a schematic top view of the turning station shown in FIG. 5.

FIG. 7 is a schematic side view of the turning station in FIG. 5.

FIG. 8 is a schematic front view of a supporting wall for the device according to the invention.

FIG. 9 is an enlarged view of a region X of FIG. 8.

FIG. 10 is an enlarged view of a vertical section through the supporting wall in region X.

### DETAILED DESCRIPTION OF EMBODIMENTS OF THE INVENTION

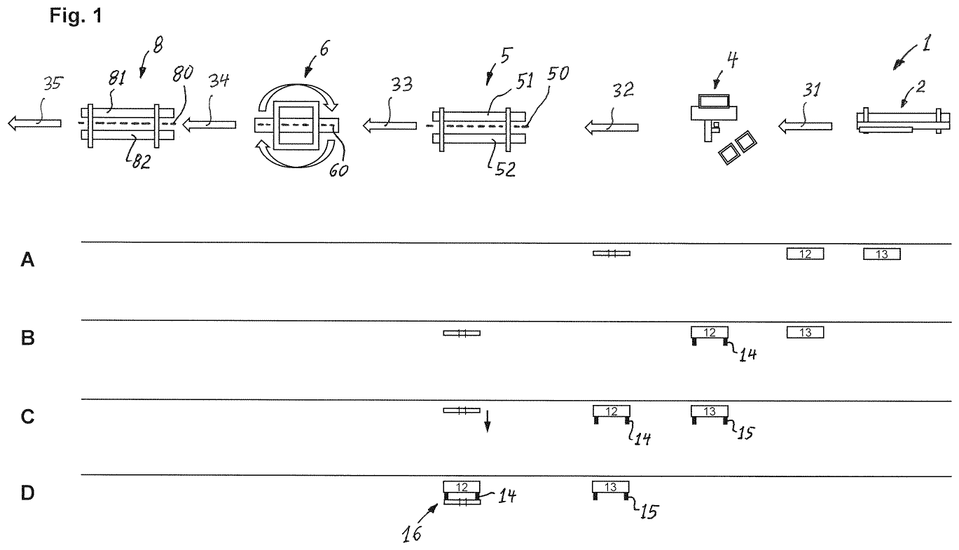

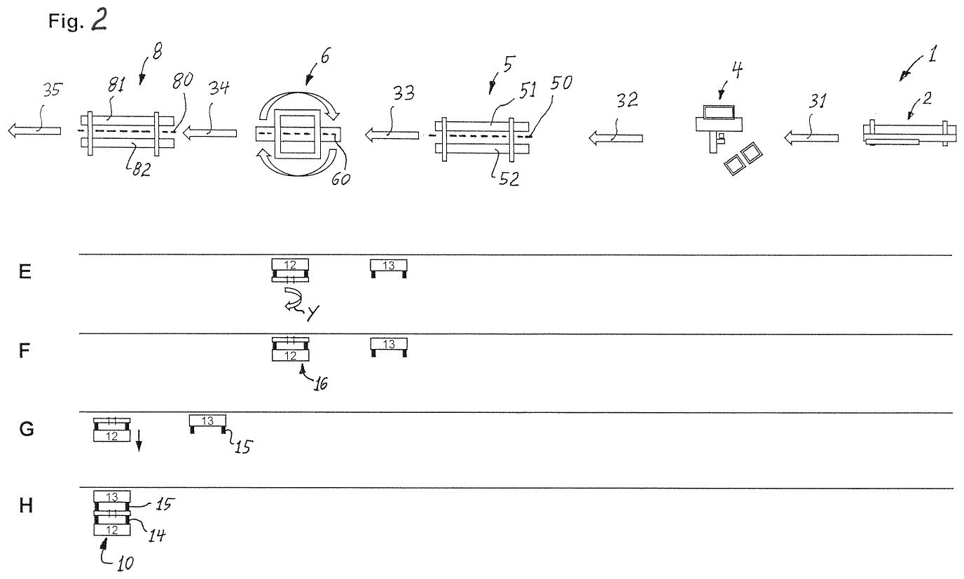

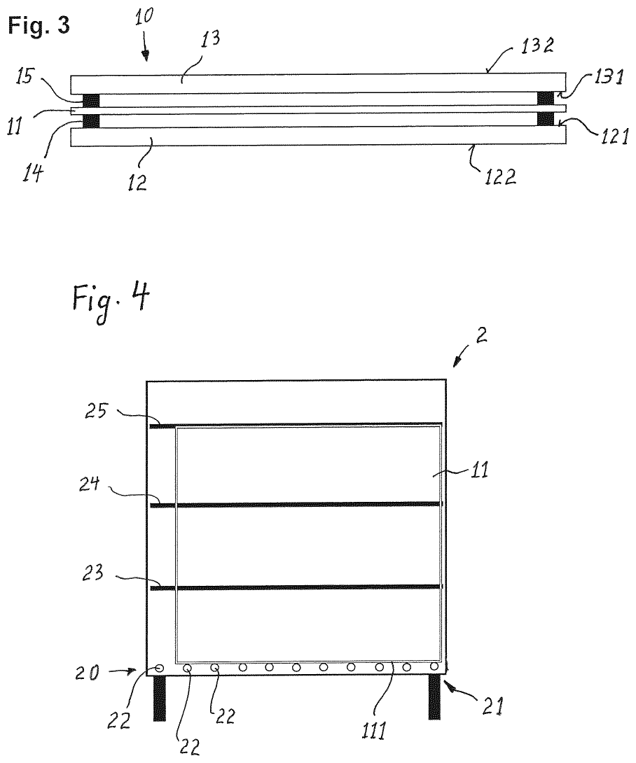

FIGS. 1 and 2 schematically illustrate a device 1, often also referred to as a production line, for assembling a triple insulating glass pane 10, which is shown in FIG. 3. The insulating glass pane 10 contains three glass sheets 11, 12 and 13. The first glass sheet 11 is a thin glass with a thickness of 1 mm or less. The second glass sheet 12 is a first outer glass having a first surface 121 facing the thin glass 11 and forming an inner surface of the insulating glass pane 10. A second surface 122 of the outer glass 12 forms an outer side of the insulating glass pane 10. The third glass sheet 13 is a second outer glass having a first surface 131 and a second surface 132, which respectively form an inner side and an outer side of the insulating glass pane 10. A first flexible spacer strand 14 is arranged between the outer glass 12 and the thin glass 11 and forms a spacer frame known per se along the edge of the outer glass 12, which holds the two glass sheets 11 and 12 at a predefined distance to each other. Accordingly, a second flexible spacer strand 15 is arranged between the outer glass 13 and the thin glass 11.

The device 1 contains a visual inspection station 2, several intermediate stations, an application station 4, a first pressing station 5, a turning station 6 and a second pressing station 8. The intermediate stations 31, 32, 33 and 34 are provided between the other stations as a transport track and/or intermediate storage. The intermediate station 35 is arranged downstream of the second pressing station 8 for removing the finished insulating glass pane 10. The intermediate stations 31, 32, 33, 34 and 35 can each contain a single-track horizontal conveyor and a supporting wall (both not shown) in a manner known per se. The visual inspection station 2, see FIG. 4, contains a horizontal conveyor 20, which is attached to a frame 21 and is formed by a row of several drivable transport rollers 22. Such horizontal conveyors 20 are known per se. A glass sheet, for example the thin glass 11 in the intermediate step shown, rests with its lower edge 111 on the horizontal conveyor 20. The visual inspection station 2 contains three supporting beams 23, 24, 25, which extend horizontally and lie in a plane slightly inclined to the vertical in order to support the upstanding thin glass 11. Depending on the height of the glass sheet to be inspected, the supporting beams 23, 24 and 25 are moved up or down. The uppermost supporting beam 25 is moved so that it supports the thin glass 11 as far up as possible at its edge. The two supporting beams 23 and 24 are moved so that the distances between the horizontal conveyor 20 and the supporting beam 23 and between the three supporting beams 23, 24 and 25 are equal. The thin glass 11 is thus very well supported so that it does not bend to an unacceptable extent. At the same time, only very little of the surface of the thin glass 11 is covered by the supporting beams, so that any defects in the thin glass 11 can still be detected very easily. The application station 4 is set up in a manner known per se for applying a pasty and then solidifying spacer strand of a thermoplastic material to a glass sheet and therefore does not need to be described in detail.

During the manufacture of the triple insulating glass pane 10 according to the invention, a thin glass 11 is fed to the inspection station 2 as the first glass sheet and checked there for defects. The thin glass 11 is then conveyed upstandingly via the intermediate station 31 through the application station 4 to the intermediate station 32. The first outer glass 12 is fed to the inspection station 2 as the second glass sheet. After being checked for defects, the outer glass 12 is conveyed to the intermediate station 31. Then, the second outer glass 13 is conveyed into the inspection station 2 as the third glass sheet and checked there for defects, see intermediate step A in FIG. 1.

The three glass sheets 11, 12 and 13 are transported onwards simultaneously until the thin glass 11 reaches the first pressing station 5 and the outer glass 12 reaches the application station 4. In the application station 4, the first spacer strand 14 is applied to the outer glass 12 so that a closed spacer frame is formed along the edge of the outer glass 12 in a manner known per se. The outer glass 13 is in waiting position in the intermediate station 31, see intermediate step B in FIG. 1.

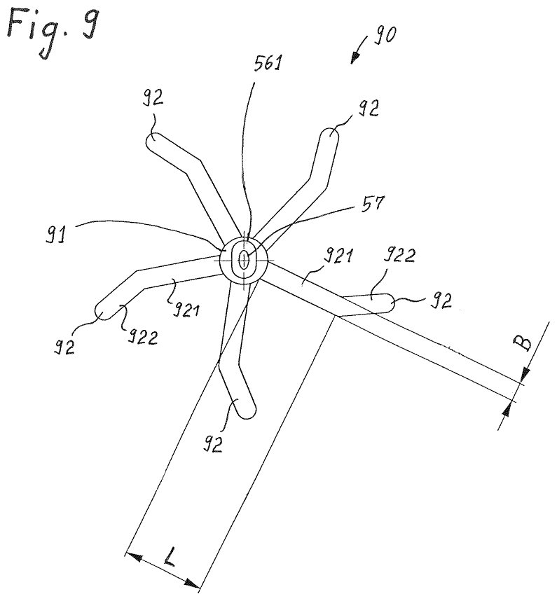

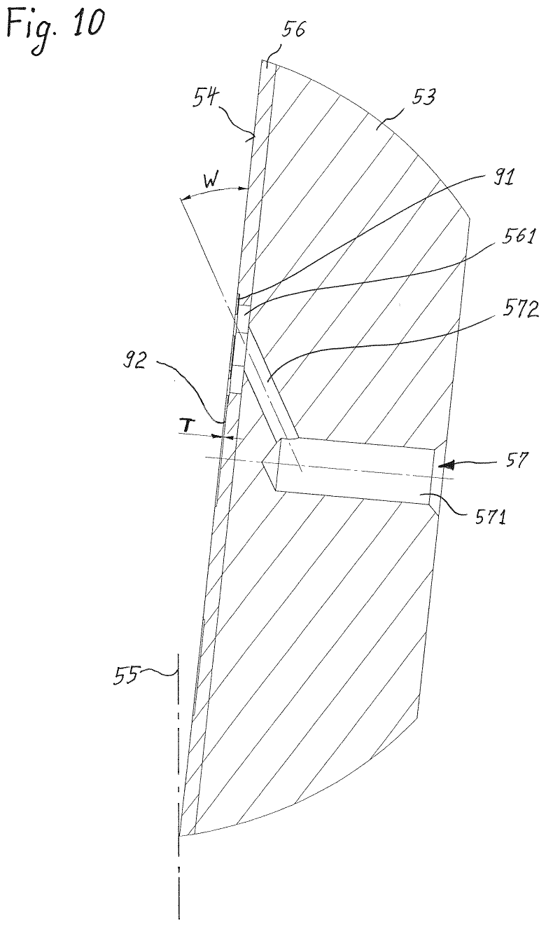

The pressing station 5 has a single-track horizontal conveyor 50, a first pressing plate 51 and a second pressing plate 52. The horizontal conveyor 50 is designed in a manner known per se and is indicated schematically by a dashed line. The first pressing plate 51 is arranged in a fixed position. The upstanding pressing plate 51 is inclined slightly backwards with respect to the vertical and supports the thin glass 11 standing on the horizontal conveyor 50 so that it does not tip forwards, i.e., to the side facing away from the pressing plate 51. The pressing plate 51 forms a supporting wall 53 with a planar supporting surface 54. The vertical or plumb line is indicated in FIG. 10 as a dotted line 55. The supporting surface 54 has an angle of 8° to the vertical 55 in order to support a glass sheet standing on the horizontal conveyor 50 and leaning against the supporting wall 53 as well as to prevent it from falling forward unintentionally. The supporting surface 54 is formed by a rubber lining 56 on the supporting wall 53. The supporting wall 53 is designed as an air cushion supporting wall, which contains a plurality of air ducts 57. The air ducts 57 open into the supporting surface 54, see FIGS. 8 to 10. A first duct section 571 of the air duct 57 is formed by a blind hole drilled into the supporting wall 53 from the rear. An end duct section 572 of the air duct 57 is connected to the duct section 571 and extends at an angle W oblique to the supporting surface 54. The angle W is 30°. The end duct section 572 has a diameter of 3 mm to 6 mm, in particular, 4 mm. When overpressure is applied to the air duct 57, an air flow thus exits obliquely to the supporting surface 54. In order not to obstruct the air flow emerging from the supporting surface 54, the rubber lining 56 contains an oval hole 561 which surrounds the end duct section 572. The air duct 57 thus extends as a through channel through the supporting wall 53 to a side of the supporting wall 53 opposite the supporting surface 54.

The second pressing plate 52 is arranged parallel to the pressing plate 51 and to the supporting surface 54. The pressing plate 52 can be displaced linearly transversely to the conveying direction of the horizontal conveyor 50, so that the distance between the two pressing plates 51 and 52 changes. The pressing plate 52 contains a suction device (not shown) which can suck a glass sheet supported by the pressing plate 51 onto the pressing plate 52. The pressing plate 52 with the glass sheet sucked onto it can then be moved away from the pressing plate 51. The design of a pressing station with these features is known per se and is therefore not described in more detail.

The thin glass 11 is sucked onto the pressing plate 52 and both together are moved away from the pressing plate 51. This is explained in detail below. After the spacer strand 14 has been applied to the outer glass 12, it is conveyed to the intermediate station 32. The outer glass 13 is conveyed into the application station 4 and the second spacer strand 15 is applied to the outer glass 13, see intermediate step C in FIG. 1.

The horizontal conveyor 50 becomes free when the thin glass 11 sucked onto the pressing plate 52 has moved away from the pressing plate 51. The outer glass 12 can then be conveyed into the pressing station 5 by the horizontal conveyor 50 until it stands congruent with the thin glass 11. The pressing plate 52 with the thin glass 11 sucked onto it is then moved back towards the pressing plate 51 until the thin glass 11 rests on the spacer strand 14 and is at a predefined distance to the outer glass 12. Before the thin glass 11 rests completely on the spacer strand 14, the space between the thin glass 11 and the outer glass 12 can be filled with a gas other than air in a manner known per se in order to increase the insulating effect. The thin glass 11 and the outer glass 12 are then joined together to form a glass assembly 16. The outer glass 13 with the applied spacer strand 15 is transported to the intermediate station 32, see intermediate step D in FIG. 1.

The distance between the pressing plates 51 and 52 is increased again and the glass assembly 16 is conveyed to the turning station 6 via the intermediate station 33. At the same time, the outer glass 13 is conveyed through the pressing station 5 to the intermediate station 33, see intermediate step E in FIG. 2.

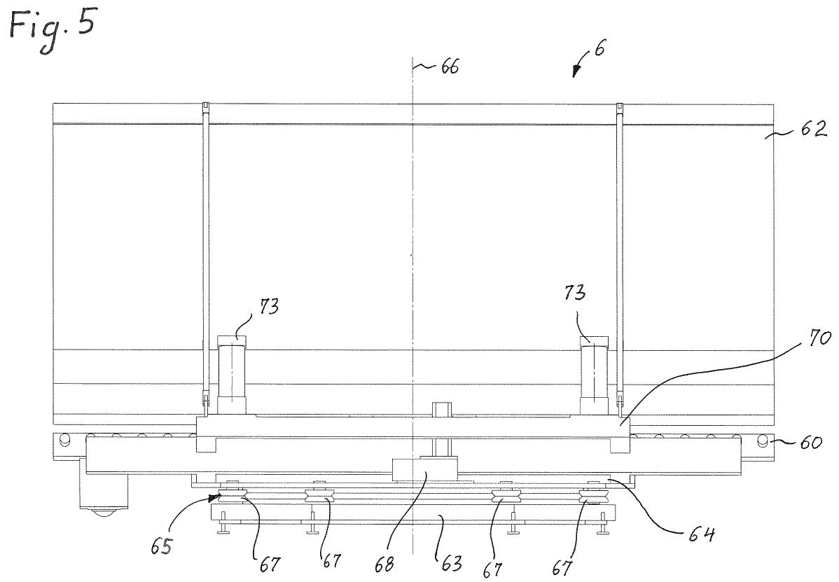

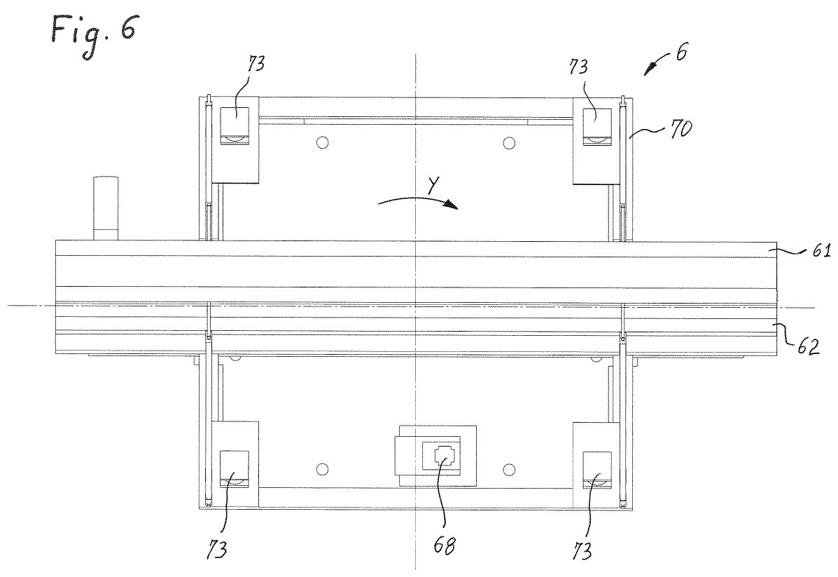

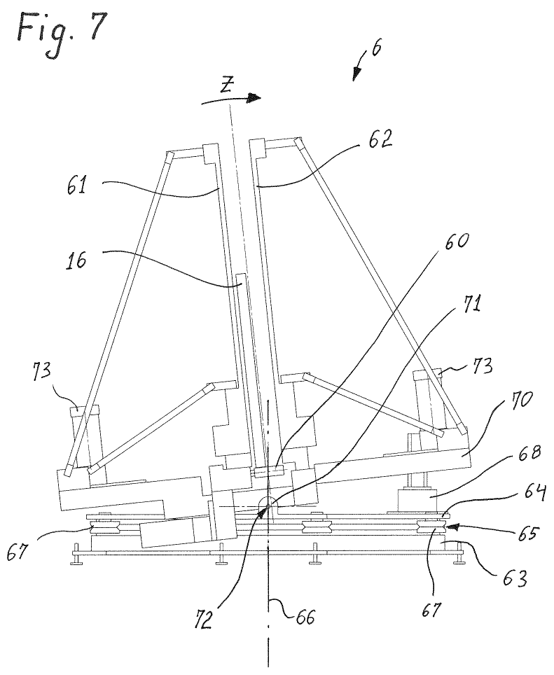

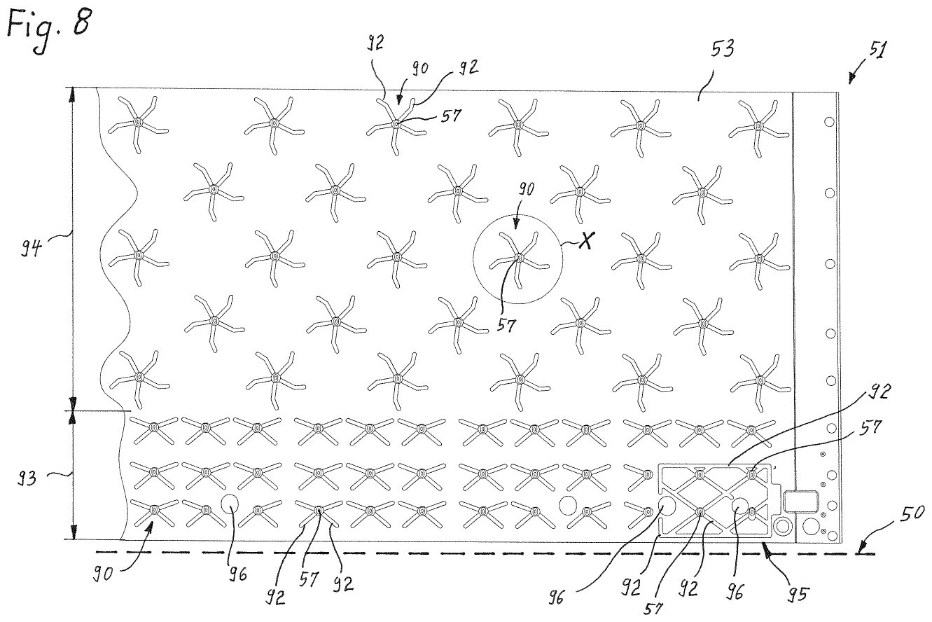

The turning station 6 has a single-track horizontal conveyor 60, a first supporting wall 61 and a second supporting wall 62, see FIGS. 5 to 7. The horizontal conveyor 60 is constructed in a manner known per se. Furthermore, the turning station 6 has a base frame 63 which stands stationary on the floor and to which a rotating frame 64 is mounted. A swivel joint 65 having a vertical axis of rotation 66 is arranged between the rotating frame 64 and the base frame 63. The swivel joint 65 is designed as a slewing ring with several guide rollers 67 arranged along the circumference. The rotating station 6 contains a rotary drive 68, by which the rotating frame 64 can be rotated in the direction of the arrow Y about the axis of rotation 66. A tilting frame 70 is mounted to the rotating frame 6. A tilting joint 71 with a horizontal tilting axis 72 is arranged between the rotating frame 64 and the tilting frame 70. The tilting axis 72 extends perpendicular to the drawing plane in FIG. 7. Tilting drives 73 in the form of pressure medium cylinders are provided in order to tilt the tilting frame 70 relative to the rotating frame 64 in the direction of the arrow Z about the tilting axis 72.

When the glass assembly 16 is conveyed upstandingly from the pressing station 5 into the turning station 6, the glass assembly 16 is supported on the outside 122 of the glass sheet 12. The horizontal conveyors 50 and 60 are in line and the supporting wall 61 is in one plane with the pressing plate 51 when the glass assembly 16 is conveyed into the turning station 6. The glass assembly 16 is then rotated by 180° in the direction of arrow Y via the rotary drive 68. Simultaneously with the rotary movement in the direction of arrow Y, the glass assembly 16 is tilted in the direction of arrow Z via the tilting drives 73. When the horizontal conveyor 60 is tilted together with the supporting walls 61 and 62, the glass assembly 16 also tilts away from the supporting wall 61 and towards the supporting wall 62. After the tilting process is complete, the glass assembly 16 is supported on the thin glass 11 by the supporting wall 62. After completion of the turning and tilting process, the horizontal conveyor 60 is again aligned with the horizontal conveyor 50 and the supporting wall 62 is in one plane with the pressing plate 51, see intermediate step F in FIG. 2.

After the glass assembly 16 has been turned, the glass assembly 16 and the outer glass 13 are transported onwards. The upstanding glass assembly 16 is supported on the thin glass 11 and conveyed into the second pressing station 8. The outer glass 13 is conveyed upstandingly through the rotating station 6 without rotation and is supported on the outside 132 by the supporting wall 62, see intermediate step G in FIG. 2.

The pressing station 8 has a single-track horizontal conveyor 80, a first pressing plate 81 and a second pressing plate 82. The first pressing plate 81 is arranged in a fixed position and is inclined slightly backwards in relation to the vertical. The pressing plate 81 supports the glass assembly 16 standing on the horizontal conveyor 80 so that it does not tip forwards, i.e., to the side facing away from the pressing plate 81. The pressing plate 81 forms an air cushion supporting wall with a planar supporting surface, which is arranged in a plane with the supporting surface 54 of the pressing plate 51. The second pressing plate 82 is arranged parallel to the pressing plate 81 and can be displaced linearly transversely to the conveying direction of the horizontal conveyor 80, so that the distance between the two pressing plates 81 and 82 changes. The pressing plate 82 contains a suction device (not shown) known per se, which can suck a glass assembly 16 supported by the pressing plate 81 onto the pressing plate 82. The glass assembly 16 is sucked onto the pressing plate 82 at the outer glass 12. The pressing plate 82 is then moved away from the pressing plate 81 with the glass assembly 16 sucked onto it. The horizontal conveyor 80 becomes free and can convey the outer glass 13 into the pressing station 8. When the outer glass 13 stands congruent with the outer glass 12, the pressing plate 82 with the glass assembly 16 sucked onto it is moved back towards the pressing plate 81. The distance between the two pressing plates 81 and 82 is reduced until the thin glass 11 rests on the spacer strand 15 and the first outer glass 12 is at a predefined distance to the second outer glass 13, see intermediate step H in FIG. 2. Before the thin glass 11 rests completely on the spacer strand 15, the space between the thin glass 11 and the outer glass 13 can be filled with a gas other than air in a manner known per se.

The suction of the outer glass 12 onto the pressing plate 82 is terminated and the distance between the pressing plates 81 and 82 is increased again. The assembled triple insulating glass pane 10 is then transported away by the horizontal conveyor 80 and the intermediate station 35, wherein the upstanding insulating glass pane 10 is supported on the outside 132.

The air ducts 57 in the pressing plate 51 can be pressurized with either negative or positive pressure. When pressurized with negative pressure, they form suction devices 90 in order to suck the flexible thin glass 11 as planar as possible onto the supporting surface 53. A suction device 90 comprises an air duct 57, a circular depression 91 and several grooves 92, see FIG. 9. The depression 91 surrounds the end duct section 572 and is connected to it. The depression 91 is open towards the supporting surface 54 and has a diameter of 20 mm or less. The grooves 92 extend radially toward the end duct section 572 and open into the depression 91. A groove 92 may comprise several groove sections 921 and 922. The two groove sections 921 and 922 extending at an angle to one another. The length L of a groove section 921, 922 extending in a straight line is at most 60 mm. The width B of the groove 92 is approximately 8 mm. The depth T of the depression 91 and the groove 92 is at most 1 mm. The depression 91 may be slightly deeper than the groove 92. The supporting surface 54 has a first supporting region 93, in which the air duct density is greater than in a second supporting region 94. This improves the air cushion transport of thin glass 11. In the first supporting region 93, the suctioned area fraction subjected to negative pressure by the air ducts 57 is greater than in the second supporting region 94. A suction device 90 contains four grooves 92 in the supporting region 93 and five grooves 92 in the supporting region 94. A third supporting region 95 is arranged in the region of a lower corner of the supporting wall 53, in which the suctioned surface area fraction is even greater than in the supporting region 93. This is achieved by the fact that some grooves 92 are connected to several air ducts 57 and intersect each other. The supporting wall 53 has holes 96 to accommodate sensors. The suction devices 90 leave out the region of the holes 96.

With the suction devices 90 according to the invention, the thin glass 11 is first sucked onto the first pressing plate 51 in the first pressing station 5. The design of the suction devices 90 can ensure that the thin glass 11 lies against the supporting surface 54 particularly planar and without forming waves. Due to the different suction effects in the supporting regions 93, 94 and 95, the thin glass first contacts the supporting surface 54 in the supporting region 95. Starting from this corner, the thin glass 11 then comes into contact with the supporting surface 54 in the supporting regions 93 and 94. This suction process, which starts from a corner of the thin glass 11, results in a full-surface and particularly planar contact of the thin glass 11 with the supporting surface 54. The formation of air pockets between the supporting surface 54 and the thin glass 11, which would lead to waviness of the thin glass 11, is avoided. The suction of the thin glass 11 onto the first pressing plate 51 is maintained while the thin glass 11 is sucked onto the second pressing plate 52. Only after the thin glass 11 has been sucked onto the second pressing plate 52, the suction to the first pressing plate 51 is terminated. As a result, the thin glass 11 can be transferred to the second pressing plate 52 in a very planar manner and placed on the spacer 14, as already described above. The suction device in the second pressing plate 52 can be designed in a manner known per se or can include suction devices 90 according to the invention.

### LIST OF REFERENCE SYMBOLS

1 Device
10 Insulating glass pane
11 Thin glass sheet
111 Bottom edge
12 Outer glass sheet
121 Surface/inside
122 Surface/outside
13 Outer glass sheet
131 Surface/inside
132 Surface/outside
14 Spacer strand
15 Spacer strand
16 Glass assembly
2 Visual inspection station
20 Horizontal conveyor
21 Frame
22 Transport rollers
23 Supporting beam
24 Supporting beam
25 Supporting beam
31 Intermediate station
32 Intermediate station
33 Intermediate station
34 Intermediate station
35 Intermediate station
4 Application station
5 Pressing station
50 Horizontal conveyor
51 Pressing plate
52 Pressing plate
53 Supporting wall
54 Supporting surface
55 The Vertical
56 Rubber lining
561 Oval hole
57 Air ducts
571 Duct section
572 End duct section
6 Turning station
61 Supporting wall
62 Supporting wall
63 Base frame
64 Rotating frame
65 Swivel joint
66 Axis of rotation
67 Guide rollers
68 Rotary drive
70 Tilting frame
71 Tilting joint
72 Tilting axle
73 Tilting drives
8 Pressing station
80 Horizontal conveyor
81 Pressing plate
82 Pressing plate
90 Suction device
91 Depression
92 Groove
921 Groove section
922 Groove section
93 Supporting region
94 Supporting region
95 Supporting region
96 Holes

What is claimed is:

1. A method of assembling a triple insulating glass pane containing two outer glasses and a thin glass between them, comprising the following steps:
a standing thin glass is conveyed through an application station into a first pressing station;
a first outer glass is conveyed upstandingly into the application station;
in the application station, a first flexible spacer strand is applied to the first outer glass so that the first spacer strand forms a frame-shaped spacer on the first outer glass;
after application of the spacer strand, the first outer glass is conveyed upstandingly from the application station into the first pressing station;
a second outer glass is conveyed upstandingly into the application station;
in the application station, a second flexible spacer strand is applied to the second outer glass so that the second spacer strand forms a frame-shaped spacer on the second outer glass;
in the first pressing station, the thin glass and the first outer glass are joined together to form a glass assembly by reducing the distance between the thin glass and the first outer glass until the thin glass rests on the first spacer strand and is at a predefined distance to the first outer glass;
the glass assembly is conveyed upstandingly from the first pressing station into a turning station, where it is turned about an upstanding axis of rotation;
after turning, the glass assembly is conveyed upstandingly from the turning station into a second pressing station;
the second outer glass is conveyed upstandingly from the application station through the first pressing station and through the turning station into the second pressing station;
in the second pressing station, the glass assembly and the second outer glass are joined together to form a triple insulating glass pane by reducing the distance between the glass assembly and the second outer glass until the thin glass rests on the second spacer strand and the first outer glass is at a predefined distance to the second outer glass;
after joining, the triple insulating glass pane is conveyed upstandingly out of the second pressing station.

2. The method according to claim 1, which comprises the following steps:
in the first pressing station, the thin glass supported by a first pressing plate is sucked onto a second pressing plate of the first pressing station;
the second pressing plate with the thin glass sucked onto it is moved away from the first pressing plate;
the first outer glass is conveyed into the first pressing station, where it is supported by the first pressing plate;
after the thin glass has been joined to the first outer glass, the suction of the thin glass to the second pressing plate is terminated.

3. The method according to claim 2, which comprises the following steps:
in the first pressing station, the thin glass supported by the first pressing plate is first sucked onto the first pressing plate;
the thin glass is sucked onto the second pressing plate before the suction of the thin glass onto the first pressing plate is terminated.

4. The method according to claim 1, comprising the following steps:
in the second pressing station, the outer glass of the glass assembly supported by a first pressing plate is sucked onto a second pressing plate of the second pressing station;
the second pressing plate with the glass assembly sucked onto it is moved away from the first pressing plate;
the second outer glass is conveyed into the second pressing station, where it is supported by the first pressing plate;
after the glass assembly has been joined to the second outer glass, the suction of the first outer glass to the second pressing plate is terminated.

5. A device for assembling a triple insulating glass pane containing two outer glasses and a thin glass between them, comprising:
an application station which is configured for applying a flexible spacer strand along an edge of an upstanding outer glass;
a first pressing station arranged downstream of the application station and having a horizontal conveyor and two parallel pressing plates, the distance between which can be varied while maintaining their parallelism and of which a first pressing plate forms an upstanding supporting wall for a glass sheet transported upstandingly on the horizontal conveyor;
a turning station arranged downstream of the first pressing station and having two parallel supporting walls and a horizontal conveyor which is assigned to both supporting walls and is rotatable together with the supporting walls about an upstanding axis of rotation which, viewed along the conveying direction, is arranged centrally with respect to the horizontal conveyor;
a second pressing station arranged downstream of the turning station and having a horizontal conveyor and two parallel pressing plates, the distance between which can be varied while maintaining their parallelism and of which a first pressing plate forms an upstanding supporting wall for a glass sheet transported upstandingly on the horizontal conveyor.

6. The device according to claim 5, which comprises a visual inspection station with a horizontal conveyor and several supporting beams for supporting a glass sheet standing on the horizontal conveyor, wherein the supporting beams extend horizontally and are displaceable upwards and downwards while being equidistant relative to one another.

7. The device according to claim 5, in which the turning station has the following features:
a rotating frame is mounted to a base frame standing stationary on the floor;
the rotating frame is rotatable relative to the base frame about a vertical axis of rotation via a swivel joint;
a tilting frame is mounted to the rotating frame and is tiltable about a horizontal tilting axis relative to the rotating frame via a tilting joint;
the supporting walls and the horizontal conveyor are fixed to the tilting frame.

8. The device according to claim 5, in which at least one of the stations has an air cushion supporting wall with a planar supporting surface, wherein a plurality of air ducts open into the supporting surface, and wherein an air flow emerges obliquely to the supporting surface from the air ducts when subjected to positive pressure.

9. The device according to claim 8, in which the supporting surface comprises a first supporting region and a second supporting region, wherein an air duct density in the first supporting region is greater than in the second supporting region, and wherein the air duct density is defined as the number of air ducts per square meter of supporting surface.

10. The device according claim 5, in which at least one of the pressing plates has a planar supporting surface into which a plurality of air ducts open, wherein the air ducts form suction devices when subjected to negative pressure, in order to suck a thin glass planar onto the supporting surface.

11. The device according to claim 10, in which the supporting surface of the pressing plate has at least one depression which is connected to an end duct section of the air duct.

12. The device according to claim 10, in which the supporting surface of the pressing plate has at least one groove which is connected to an end duct section of the air duct.

13. The device according to claim 12, in which the groove contains at least two groove sections extending at an angle to one another.

14. The device according to claim 10, in which the supporting surface has a first supporting region and a second supporting region, wherein a suctioned area fraction in the first supporting region is greater than in the second supporting region, and wherein the suctioned area fraction is defined as the quotient of the area subjected to negative pressure by the air ducts and the total area of the respective supporting region.

15. The device according to claim 10, in which the air ducts in the pressing plate can optionally be subjected to negative pressure or positive pressure.
